(19) United States
(12) Patent Application Publication
(10) Pub. No.: US 2016/0043677 A1
(43) Pub. Date: Feb. 11, 2016

(54) CONTROL SYSTEM FOR ROTARY ELECTRIC MACHINE AND METHOD FOR CONTROLLING THE SAME

(71) Applicant: TOYOTA JIDOSHA KABUSHIKI KAISHA, Toyota-shi, Aichi-ken (JP)

(72) Inventors: Tetsuya MIURA, Miyoshi-shi, Aichi-ken (JP); Yasuhide YAGYU, Nagakute-shi, Aichi-ken (JP); Takanori KADOTA, Toyota-shi, Aichi-ken (JP)

(73) Assignee: TOYOTA JIDOSHA KABUSHIKI KAISHA, Toyota-shi, Aichi-ken (JP)

(21) Appl. No.: 14/782,017

(22) PCT Filed: Apr. 1, 2014
(86) PCT No.: PCT/IB2014/000458

§ 371 Date: Oct. 2, 2015

(30) Foreign Application Priority Data
Apr. 2, 2013 (JP) 2013-077286

(51) Int. Cl. H02P 21/00; H02P 6/14; H02K 7/108; H02P 6/08

(52) U.S. Cl. CPC H02P 21/0035; H02P 6/08; H02P 6/14; H02K 7/108

(57) ABSTRACT

A rotary electric machine control system 10 includes a controller 70, and a rotor 28 including a first rotor element 40 and a second rotor element 42 which are rotatable inside of the stator 24 and disposed to be separated from each other in axial direction. The first rotor element 40 includes a first magnet and is fixed to a rotary shaft 26. The second rotor element 42 includes a second magnet, and is rotatably provided to the rotary shaft 26. The controller 70 performs vector control of the stator coil current for transition of an inter-rotor phase, a relative phase difference of the second rotor element 42 in relation to the first rotor element 40.

### BACKGROUND OF THE INVENTION

1. Field of the Invention

The present invention relates to a control system for a rotary electric machine and a method for controlling the same, and also relates to a technique for varying an effective magnetic flux amount of a rotor.

2. Description of Related Art

Magnetic flux variable typed rotary electric machines have been known, as described in Japanese Patent Application Publication No. 2010-154699 (JP 2010-154699 A). The rotary electric machine described in JP 2010-154699 A is configured to change an effective magnetic flux amount of a rotor contributing to a torque in response to variation in phase relationship between two rotors by changing a position relationship of the rotor equipped with two magnets which are disposed to be separated in a rotary shaft direction with an actuator.

The magnetic flux variable typed rotary electric machine described in JP 2010-154699 A requires an actuator acting as a specialized driving source for changing the effective magnetic flux amount of the rotor. Thereby, it causes the growth in size and cost of the rotary electric machine.

### SUMMARY OF THE INVENTION

The present invention varies an elective magnetic flux amount of a rotor without need for specialized driving sources, in a control system for a rotary electric machine and a method for controlling the same.

The first aspect of the present invention relates to a control system. The control system includes a rotary electric machine and, a controller. The rotary electric machine includes a stator containing stator coils which are disposed at plural positions in circumferential direction, and a rotor including a first rotor element and a second rotor element which are rotatable inside of the stator and disposed to be separated from each other in axial direction. The first rotor element includes a plurality of first magnets with different polarities disposed alternately in circumferential direction, and is fixed to a rotary shaft. The second rotor element includes a plurality of second magnets with different polarities disposed alternately in circumferential direction, and is fixed to a rotary shaft. The controller is a component for controlling a stator coil current. The controller performs vector control of the stator coil current for transition of an inter-rotor phase, which is a relative phase difference of the second rotor element in relation to the first rotor element.

The second aspect of the present invention relates to a method for controlling a control system including a rotary electric machine and a controller. The rotary electric machine includes a stator containing stator coils which, are disposed at plural positions in circumferential direction, and a rotor including a first rotor element and a second rotor element which are rotatable inside of the stator and disposed to be separated from each other in axial direction. The first rotor element includes a plurality of first magnets with different polarities disposed alternately in circumferential direction, and is fixed to a rotary shaft. The second rotor element includes a plurality of second magnets with different polarities disposed alternately in circumferential direction, and is fixed to a rotary shaft. The controller is a component for controlling a stator coil current. In the method for controlling the same, the controller performs vector control of the stator coil current for transition of an inter-rotor phase, which is a relative phase difference of the second rotor element in relation to the first rotor element.

According to the control system of the rotary electric machine and the method for controlling the same of the present invention, it is possible to alter the phase relationship between the first rotor element and the second rotor element without need for specialized driving sources, so as to alter an effective magnetic flux of the rotor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 shows a configuration of a control system for a rotary electric machine according to the first embodiment of the present invention;

FIG. 2 shows a perspective view of a first magnet of a first rotor element in A-A cross-section of FIG. 1;

FIG. 3 shows a first rotor element and a second rotor element viewed from outer diameter side in FIG. 2;

FIG. 4 shows a schematic view of the rotor of FIG. 3 which is viewed in axial direction and viewed towards the first rotor element side from the second rotor element side;

FIG. 5 shows a schematic view showing that a stator magnetic field is generated so as to alter an inter-rotor phase in FIG. 3.

FIG. 6 shows a view showing a relationship between an inter-rotor phase & and an inter-rotor magnetic torque acting between rotor elements, according to an embodiment of the present invention;

FIG. 7 shows a positive direction of the inter-rotor magnetic torque in FIG. 6;

FIG. 8A shows a view showing a transition from polar reverse state to polar same state, showing polar reverse state (magnetic flux 0%), in FIG. 2;

FIG. 8B shows a view showing a transition from polar reverse state to polar same state, showing polar transition state (magnetic flux≦50%), in FIG. 2;

FIG. 8C shows a view showing a transition from polar reverse state to polar same state, showing polar transition state (magnetic flux≧50%), in FIG. 2;

FIG. 8D shows a view showing a transition from polar reverse state to polar same state, showing polar same state (magnetic flux 100%), in FIG. 2;

FIG. 9A corresponds to FIG. 8A, and shows a state of transition from polar reverse state to polar same state viewed from outer diameter side of a rotor, showing polar reverse state (magnetic flux 0%);

FIG. 9B corresponds to FIG. 8B, and shows a state of transition from polar reverse state to polar same state viewed from outer diameter side of a rotor, showing polarity transition state (magnetic flux≦50%);

FIG. 9C corresponds to FIG. 8C, and shows a state of transition from polar reverse state to polar same state viewed from outer diameter side of a rotor, showing polarity transition state (magnetic flux≧50%);

FIG. 9D corresponds to FIG. 8D, and shows a state of transition from polar reverse state to polar same state viewed from outer diameter side of a rotor, showing polar same state (magnetic flux 100%);

FIG. 10 shows a view showing a relationship between inter-rotor phase θe and stability of rotor phase relationship;

FIG. 11A shows a view showing a transition from polar same state to polar reverse state, showing polar same state (magnetic flux 100%), in FIG. 2;

FIG. 11B shows a view showing a transition from polar same state to polar reverse state, showing polarity transition state, in FIG. 2;

FIG. 11C shows a view showing a transition from polar same state to polar reverse state, showing polar reverse state (magnetic flux 0%), in FIG. 2;

FIG. 12A corresponds to FIG. 11A, and shows a state of transition from polar same state to polar reverse state viewed from outer diameter side of a rotor, showing polar same state (magnetic flux 100%);

FIG. 12B corresponds to FIG. 11B, and shows a state of transition from polar same state to polar reverse state viewed from outer diameter side of a rotor, showing polarity transition state;

FIG. 12C corresponds to FIG. 11C, and shows a state, of transition from polar same state to polar reverse state viewed from outer diameter side of a rotor, showing polar reverse state (magnetic flux 0%);

FIG. 13 shows a configuration of a control system for a rotary electric machine according to the second embodiment of the present invention;

FIG. 14A shows a view showing a relationship between axis rotary angle (electric angle) and stator induction voltage under different inter-rotor phase θe, showing polar reverse state (magnetic flux 0%), in second embodiment;

FIG. 14B shows a view showing a relationship between axis rotary angle (electric angle) and stator induction voltage under different inter-rotor phase θe, showing polarity transition state (magnetic flux≦50%), in second embodiment;

FIG. 14C shows a view showing a relationship between axis rotary angle (electric angle) and stator induction voltage under different inter-rotor phase θe, showing polar same state (magnetic flux 100%), in second embodiment;

FIG. 14D shows a view showing a relationship between axis rotary angle (electric angle) and stator induction voltage under different inter-rotor phase θe, showing polarity transition state (magnetic flux≧50%), in second embodiment;

FIG. 15 shows a cross-sectional view of a control system for a rotary electric machine, according to the third embodiment of the present invention;

FIG. 16 shows a view showing a relationship between an inter-rotor phase θe, and torque which is generated in the second rotor element by stator magnetic field and an inter-rotor magnetic torque, according to the fourth embodiment of the present invention.

### DETAILED DESCRIPTION OF EMBODIMENTS

Hereinafter, embodiments of the present invention will be explained with reference to drawings. Hereinafter, same components will be explained with use of same symbols in all drawings.

### First Embodiment

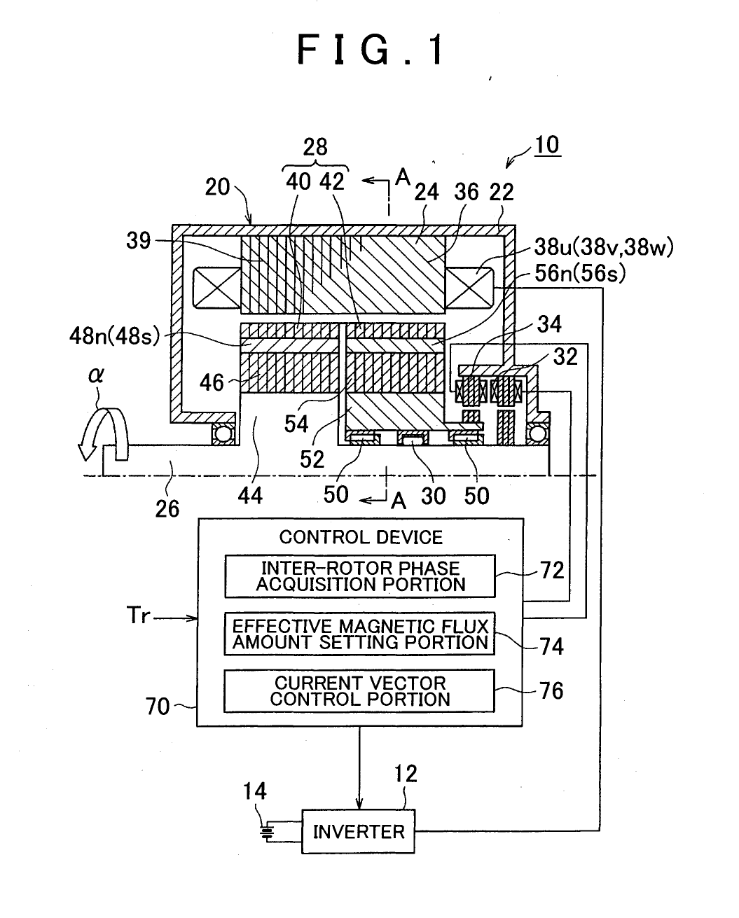

FIG. 1 shows a rotary electric machine control system 10 according to the first embodiment of the present invention. The rotary electric machine control system 10 is provided with a rotary electric machine 20, an inverter 12 acting as a driving circuit, an electric storage device 14 acting as a power source, and a controller 70. The rotary electric machine control system 10 is mounted to electric vehicles such as hybrid vehicles, electric vehicles, or fuel cell vehicles, and utilized to drive wheels (not shown) with use of the rotary electric machine 20 as a motor. The rotary electric machine 20 may be used as a generator, a motor, or a motor generator with functions of both the motor and the generator.

The rotary electric machine 20 includes a stator 24 fixed inside of a case 22, a rotary shaft 26 which is provided rotatably to the case 22 with a bearing, a rotor 28 provided at a periphery of the rotary shaft 26, a one-direction clutch 30 and rotation angle sensors 32, 34. The rotary electric machine 20 makes variable an effective magnetic flux which is generated in the rotor 28 as mentioned below and contributes to, torque.

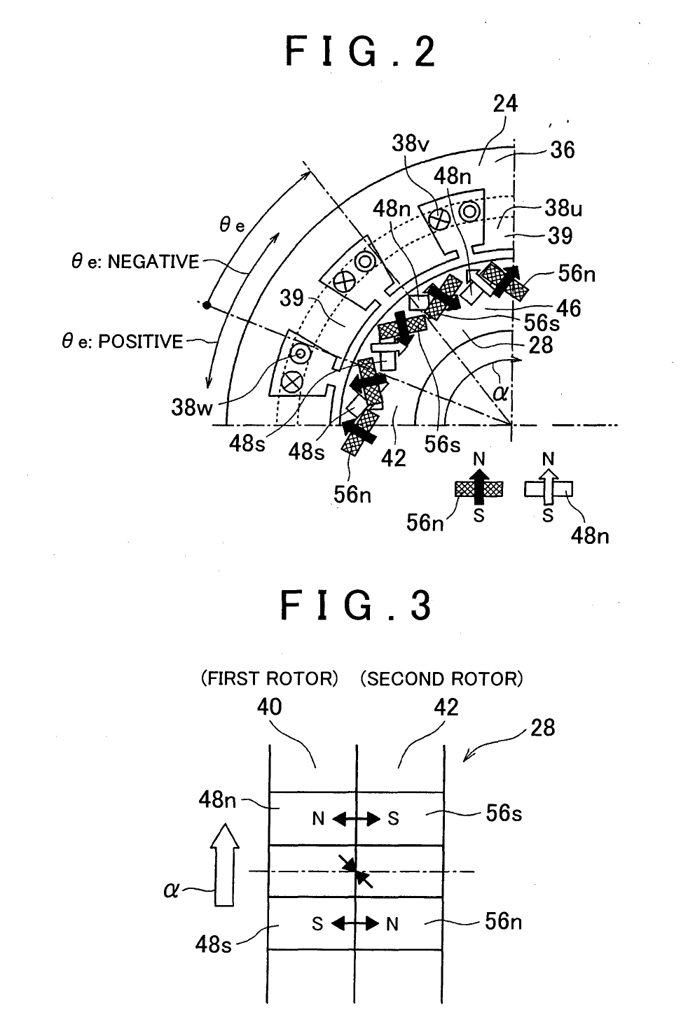

As shown in FIG. 2, the stator 24 includes a stator core 36 formed of a laminate of electromagnetic plates; three-phase stator coils with plural phases of U-phase, V-phase and W-phase 38u, 38v, 38w. The three-phase stator coils 38u, 38v, 38w are wound by concentrated winding or distributed winding along a plurality of teeth 39 provided to an interior circumferential surface of the stator core 36. Hereinafter, the stator coils 38u, 38v, 38w may be simply referred to as a stator coil 38. The stator core 36 may be formed of a pressed powder core which is formed by compression molding of magnetic powder.

When, stator current, three-phase alternating current flows through the stator coil 38, a plurality of the teeth 39 are magnetized to generate rotary magnetic field in the stator 24.

As shown in FIG. 1, the rotor 28 includes a first rotor element 40 (provided in left side of the drawing) and a second rotor element 42 (provided in right side of the drawing) which are rotatable inside of the stator 24 and disposed to be separated from each other in axial direction. The first rotor element 40 includes a tubular first core 46 fixed at a periphery of tubular protrusion 44 which is provided integrally at a periphery of the rotary shaft 26, and first magnets 48n, 48s which are disposed at plural positions in a circumference direction of the first core 46. The first rotor element 40 is disposed at an inside in diameter direction to face one side portion in axial direction of the stator core 36 (left side portion in the drawing) with a predetermined interval, and is rotatable in relation to the stator 24. The rotor 28 can be disposed inside of the stator 24 so as to interact with magnetic field generated in the stator coil 38.

The second rotor element 42 includes an interior holding portion 52 which is provided rotatably at another portion (right side portion in the drawing) away from the first rotor element 40 in axial direction in a periphery of the rotary shaft 26, with a bearing 50 such as a needle bearing; a second core 54 fixed at a periphery of the interior holding portion 52; second magnets 56n, 56s which are disposed at plural portions in circumferential direction of the second core 54. The second rotor element 42 is disposed at an inside in diameter direction to face the other side portion in axial direction of the stator core 36 (right side portion in the drawing) at a predetermined interval, and is rotatable in relation to the stator 24. The interior holding portion 52 is formed of a magnetic material such as iron, or non-magnetic metal.

Each of cores 46, 54 is formed of a laminate of electromagnetic metal plates. Each of magnets 48n, 48s, 56n, 56s is paramagnet. The first magnets 48n, 48s are disposed to be inserted at plural portions in circumferential direction of the first core 46 in its axial direction. The second magnets 56n, 56s are disposed to be inserted at, plural portions in circumferential direction of the second core 54 in its axial direction. As shown in FIG. 2, the magnets 48n, 48s, 56n, 56s are disposed to form V-shaped pairs of two magnets at plural portions in circumferential direction of each of the cores 46, 54. Polarities of plural groups of the magnets 48n, 48s, 56n, 56s are different alternately in rotary direction of the rotor. The intervals of plural groups of the first magnets 48n, 48s and the second magnets 56n, 56s are equal each other in circumferential direction. N-pole of each magnet 48n, 56n is placed in outer peripheral side. S-pole of each magnet 48s, 56s is placed in outer peripheral side. Each of the cores 46, 54 may be formed of a pressed powder core.

The effective magnetic flux amount of the rotor 28 alters according to variation in the phase relationship between the first rotor element 40 and the second rotor element 42. The “effective magnetic flux amount” refers to a magnetic flux amount which substantially acts on the stator 24 by combined magnetic flux of the two rotor elements 40, 42. The effective magnetic flux amounts to the maximum in the polar same state in which magnets 48n, 48s, 56n, 56s with the homopolarity are disposed to be same phase in circumferential direction in the two rotor elements 40, 42, for example. In this instance, the effective magnetic flux is 100%. When the effective magnetic flux amount is expressed with use of %, it refers to the ratio of the effective magnetic flux with respect to the effective magnetic flux of 100% in the polar same state. Meanwhile, when the second rotor element 42 is rotated in relation to the rotary shaft 26 to cause deviation of circumferential directional positions of homopolar magnets 48n, 48s, 56n, 56s in two of the rotor elements 40, 42, the effective magnetic flux decreases. The effective magnetic flux is to zero, in case of the polar reverse state in which the homopolar magnets 48n, 48s, 56n, 56s are deviated by 180 degrees in electrical angle in two of the rotor elements 40, 42, and antipolar magnets 48n, 48s, 56n, 56s are disposed to achieve same phase in circumferential direction, for example. In the polar reverse state, the effective magnetic flux is 0%.

The one-direction clutch 30 is provided between the interior holding portion 52 of the second rotor element 42 and circumferential surface of the rotary shaft 26. The one-direction clutch 30 allows the second rotor element 42 to rotate about the rotary shaft 26 in only one direction opposite of arrow α shown in FIG. 1 and FIG. 2, preventing the second rotor element 42 from rotating in arrow α direction. The arrow α direction is the positive torque generation direction of the rotary shaft 26.

The rotation angle sensor 32 detects a rotation angle of the rotary shaft 26, and sends a signal indicating the rotation angle to the controller 70. The rotation angle sensor 34 detects a rotation angle of the second rotor element 42, and sends a signal indicating the rotation angle to the controller 70.

The rotary electric machine 20 is driven by an inverter 12 of the rotary electric machine control system 10. The inverter 12 is connected to the power storage device 14, controlled by the controller 70, and converts direct current from the power storage device 14 into three-phase, U-phase, V-phase and W-phase alternating currents. The power storage device 14 may be capacitor. A voltage conversion device may be provided between the power storage device 14 and the inverter 12 for converting amplitude of the voltage of the power storage device 14 to be supplied to the inverter 12.

The controller 70 includes a microcomputer having CPU and memory, and has an inter-rotor phase acquisition portion 72, an effective magnetic flux amount, setting portion 74 and a current vector control portion 76. The controller 70 drives the rotor 28 to rotate in the arrow α direction shown in FIG. 1 and FIG. 2, according to an input torque command value Tr. For example, when the rotary electric machine 20 is utilized as a driving motor of vehicle, the torque command value Tr of the rotary electric machine 20 is calculated in another controller (not shown) according to an acceleration command signal input from acceleration pedal sensor (not shown) or the like of vehicle. The controller 70 controls the switching element of the inverter 12 according to the torque command value Tr input from another controller, for driving the inverter 12 to control the rotary electric machine 20. In this instance, the current vector control portion 76 calculates a current vector command defined by d-axis current command Id* and q-axis current command Iq* in dq coordinate system according to the torque command value Tr, converts the current vector command into three-phase current command, and then performs the current vector control for controlling the stator coil current in each phase. In this instance, after two- or three-phase stator coil current is detected with a current sensor (not shown), the controller 70 may perform a feedback control of the stator current with the d-axis current Id and the q-axis current Iq obtained from the detection value. The controller 70 may be configured by a plurality of controllers which are separated according to the function. The acceleration command signal may be input in the controller 70 for calculation of the torque command value Tr.

The controller 70 also has a function of controlling the effective magnetic flux amount of the rotor 28. The inter-rotor phase acquisition portion 72 acquires the inter-rotor phase θe indicating a relative phase difference of the second rotor element 42 in relation to the first rotor element 40, according to the rotation angle of the rotary shaft 26 acquired from each of the rotation angle sensors 32, 34 and the second rotor element 42 (See FIG. 2). The relative phase difference is positive or negative, depending on direction of the deviation.

The effective magnetic flux amount setting portion 74 sets an effective magnetic flux amount according to a predetermined requirement. When the rotation speed of the rotor 28 is high, for example, too high effective magnetic flux amount may increase reverse voltage acting on the stator coil 38 from the rotor 28 to cause a decreased output. In view of this instance, it is possible to suppress the decrease in the output by decreasing the effective magnetic flux to a predetermined desired value.

The current vector control portion 76 controls the stator coil current by current vector control according to the effective magnetic flux amount set at the effective magnetic flux amount setting portion 74. In this instance, the current vector control portion 76 enables to generate magnetic field at an arbitrary effective magnetic flux amount, according to a position relationship of the magnets 48n, 48s, 56n, 56s of each rotor element 40, 42. In this instance, the current vector control portion 76 generates a torque for allowing the second rotor element 42 to rotate in relation to the first rotor element 40, and performs vector control of the stator coil current so as to generate stator magnetic field for transition of the inter-rotor phase θe between two rotor elements 40, 42. The “inter-rotor phase θe” refers to the relative phase difference of the second rotor element 42 in relation to the first rotor element 40 in terms of electrical angle. The inter-rotor phase θe is defined to be positive, when the homopolar N-pole magnet or S-pole magnet as the reference magnet of the second rotor element 42 is displaced in the counterclockwise direction of FIG. 2 with respect to the position of N-pole magnet or S-pole magnet of the first rotor element 40 as viewed in the direction of the rotary shaft 26 from the second rotor element 42 side to the first rotor element 40. The inter-rotor phase θe is defined to be negative, when the N-pole magnet or S-pole magnet of the second rotor element 42 is displaced in the clockwise direction of FIG. 2. Polar same state is achieved by the inter-rotor phase θe of 0°. Polar reverse state is achieved when the inter-rotor phase is deviated by 180° in either of positive and negative directions. The current vector control portion 76 alters the effective magnetic flux amount of the rotor 28 according to the transition of inter-rotor phase θe. Next, explanation will be given as to an idea of the current vector control for the control of effective magnetic flux and its control method.

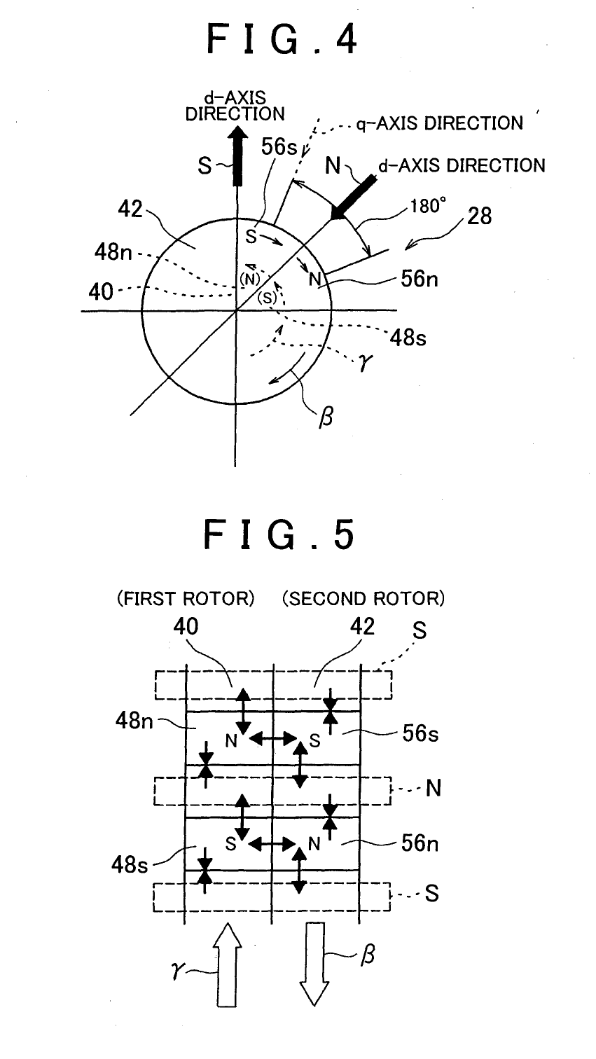

FIG. 3 shows the first rotor element 40 and the second rotor element 42, which are viewed from outer diameter side in FIG. 2. FIG. 4 shows a schematic view of the rotor 28 of FIG. 3 viewed in axial direction, which is viewed towards the first rotor element 40 side from the second rotor element 42 side. In FIG. 4, (N), (S) refer to the magnets 48n, 48s in the first rotor element 40 side disposed behind the second rotor, element 42. The number of each magnet 48n, 48s, 56n, 56s in FIG. 4 is smaller than actual number of that, for simplification. FIG. 3 and FIG. 4 show the polar reverse state achieving coincidence in phase in circumferential directions of magnets 48n, 48s, 56n, 56s with antipolarity of each rotor element 40, 42. FIG. 3 and FIG. 5 described below shows an absorption force acting in an arrow direction in which the magnets are displaced to be away from each other, and a repulsion force acting in an arrow direction in which the magnets are displaced to be closer to each other. In this instance, as shown in FIG. 3, in the magnets 48n, 48s, 56n, 56s of two rotor elements 40, 42, the absorption force is generated between antipolar magnets facing each other in the axial direction, and the repulsion force is generated between homopolar magnets facing each other in a direction deviated from the axial direction. However, as the absorption force between antipolar magnets facing each other in the axial direction is stronger. As a result, it makes the most strongest the rotor phase relationship, the phase relationship between the rotor elements 40, 42 in a polar reverse state.

Next, in this state, in order to control the transition of the rotor phase relationship between the rotor elements 40, 42 to a different transition relationship, explanations are given as to stator magnetic flux in which apparent N-pole and S-pole magnetic poles are disposed at positions in d-axis direction shown in FIG. 4. In this instance, as S-pole is positioned in upper left side of the drawing in the second rotor element 42, the second rotor element 42 rotates in β direction by magnetic attraction force of the stator magnetic flux. Meanwhile, as S-pole is positioned in lower right side of the drawing in the first rotor element 40, the first rotor element 40 rotates in γ direction by magnetic attraction force of the stator magnetic flux. In this instance, both of the rotor elements 40, 42 rotate in opposite directions, thus generating a torque not contributing to rotation of the whole of the rotor 28. In view of this, the controller 70 generates the torque allowing the first rotor element 40 and the second rotor element 42 to rotate in opposite directions, and performs vector control of the stator coil current so as to generate the torque not contributing to rotation of the whole of the rotor 28. For example, it is possible to perform vector control of the stator coil current so as to generate a stator magnetic field allowing magnetic flux to be generated at a position torque in which such a torque can be generated. As described below, this configuration allows the second rotor element 42 rotatable in relation to the rotary shaft 26 to rotate the first rotor element 40 fixed to the rotary shaft 26. In this instance, it is possible to determine the stator magnetic field so as to generate the stator magnetic flux in d-axis direction of FIG. 4, with respect to the combined magnetic flux of both rotor elements 40, 42 and to generate the torque to rotate the second rotor element 42 in relation to the first rotor element 40. Such a stator magnetic flux can be determined by performing the current vector control for determination of current command in d-q coordinate system. FIG. 4 shows an instance, in which d-axis magnetic flux is generated while q-axis magnetic flux is not generated, and only d-axis current is generated. However, in order to rotate the rotor 28 in a direction of FIG. 1 and FIG. 2, a positive direction of the rotor 28, it is also possible to generate q-axis current for generating q-axis magnetic flux, together with d-axis current.

FIG. 5 shows a schematic view corresponding to FIG. 3, in case the stator magnetic field is generated in this way. As shown by dotted frame in FIG. 5, apparent common N-pole is generated in outer diameter side between N and S of the first rotor element 40 and outer diameter side between S and N of the second rotor element 42, and the stator magnetic flux is generated to form apparent S-pole in outer diameter sides of both sides of circumferential direction. In this instance, the first rotor element 40 is transferred in γ direction, upward direction of FIG. 5, while the second rotor element 42 is transferred in β direction, downward direction of FIG. 5, so as to form torques allowing the rotors to rotate in opposite directions. The controller 70 performs transitions of the rotor phase relationship from polar reverse state to polar same state by generating this torque. In this instance, the transition of the abovementioned inter-rotor phase θe (FIG. 2) occurs.

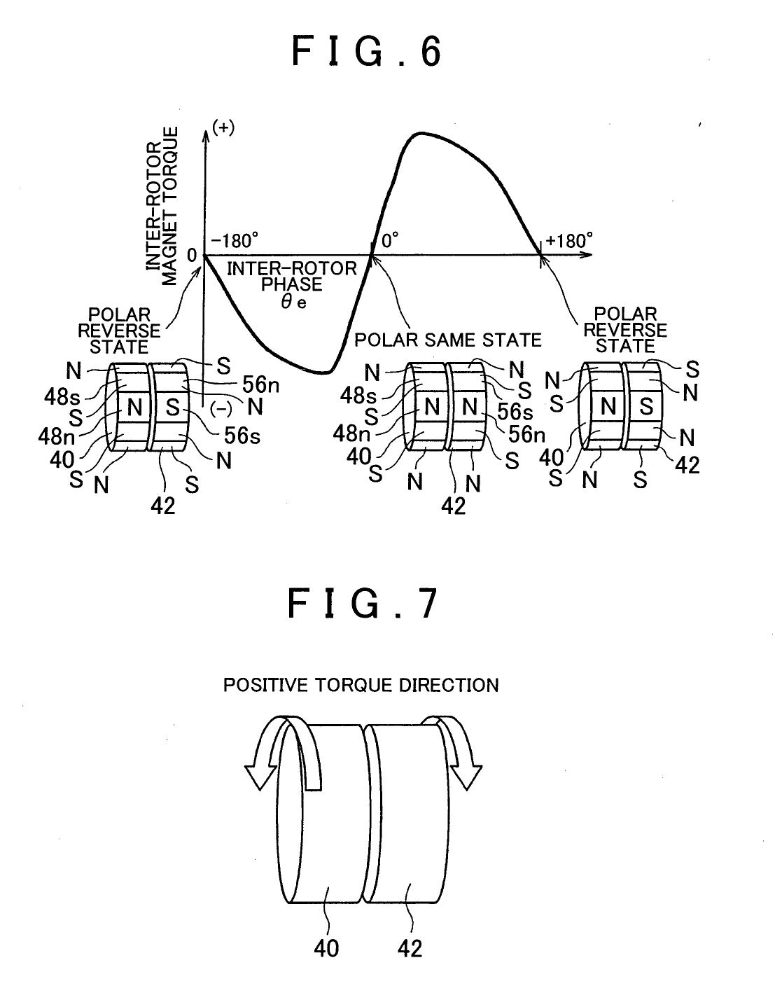

For example, as shown in FIG. 6, the rotor phase relationship includes the polar reverse state and the polar same state. The polar same state is a state achieving coincidence in phase between magnets with homopolarity of each rotor element 40, 42 in their circumferential directions. The controller 70 generates the torque allowing each rotor element 40, 42 to rotate in opposite directions when the rotor phase relationship is between the polar reverse state and polar same state, and performs vector control of the stator coil current so as to generate the torque not contributing to rotation of the whole of the rotor 28. For example, the controller 70 performs vector control of the stator coil current so as to generate the stator magnetic flux causing magnetic flux at positions in which the torque is generated. In this instance, the controller 70 performs vector control of the stator coil current for transitions of the inter-rotor phase θe from polar reverse state to polar same state.

FIG. 6 shows a relationship between the inter-rotor phase θe and the inter-rotor magnetic torque acting between the rotor elements 40 and 42. The positive direction of the “inter-rotor magnetic torque” is defined as shown in FIG. 7. As shown in FIG. 6, when the inter-rotor phase θe is −180°<θe<0°, the inter-rotor magnetic torque is “negative”. In this instance, the torque in the negative direction, that is, the torque directed towards θe=−180°, is acted on the rotor elements 40, 42 by an attraction force between N-pole magnets 48n, 56n and S-pole magnets 56s, 56s in each rotor element 40, 42. In this instance, the torque acts on each rotor element 40, 42 in a direction opposite to the direction shown in FIG. 7. In view of this, in order to alter θe in the positive direction, it is necessary to generate the torque in the direction shown in FIG. 7, opposite to the above direction.

Meanwhile, when the inter-rotor phase θe is 0°<θe<180°, the inter-rotor magnetic torque is “positive”. In this instance, the torque in the positive direction, that is, the torque directed towards θe=+180°, is acted between the rotor elements 40, 42 by an attraction force between N-pole magnets 48n, 56n and S-pole magnets 56s, 56s in each rotor element 40, 42. In this instance, the torque acts on each rotor element 40, 42 in the same direction as that shown in FIG. 7. In view of this, in order to alter θe in the positive direction, it is possible to alter θe=+180° by altering θe into θe>0° even temporarily from θe=0° without need for an external driving torque deriving from positive inter-rotor magnetic torque.

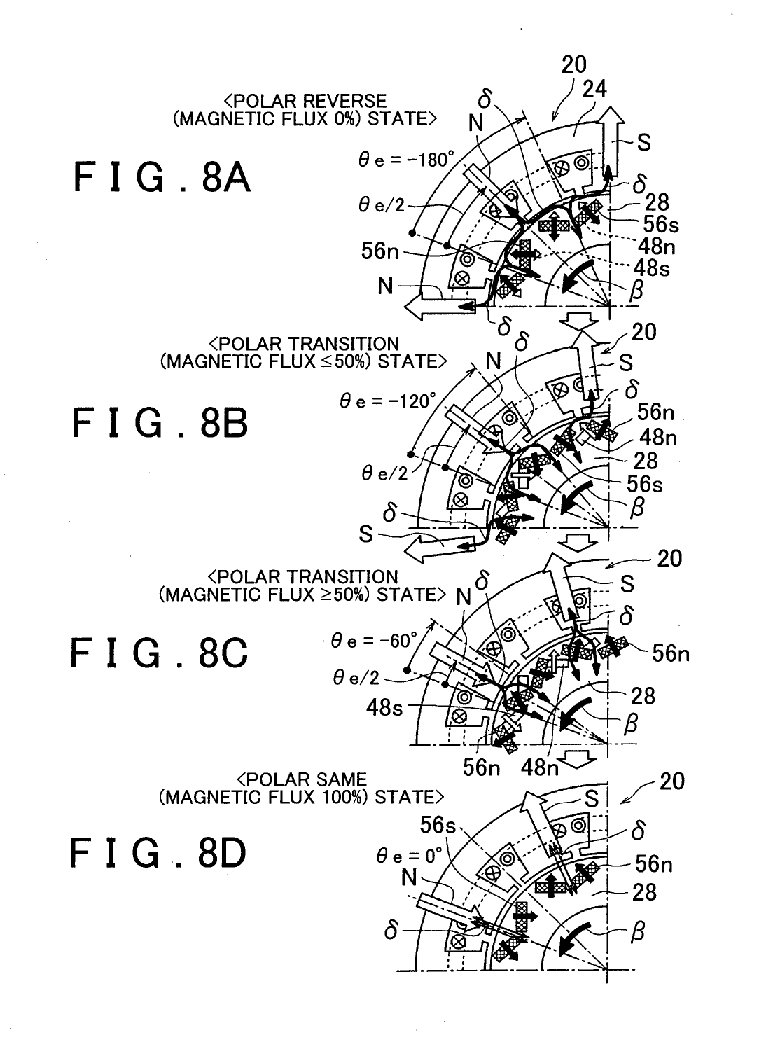

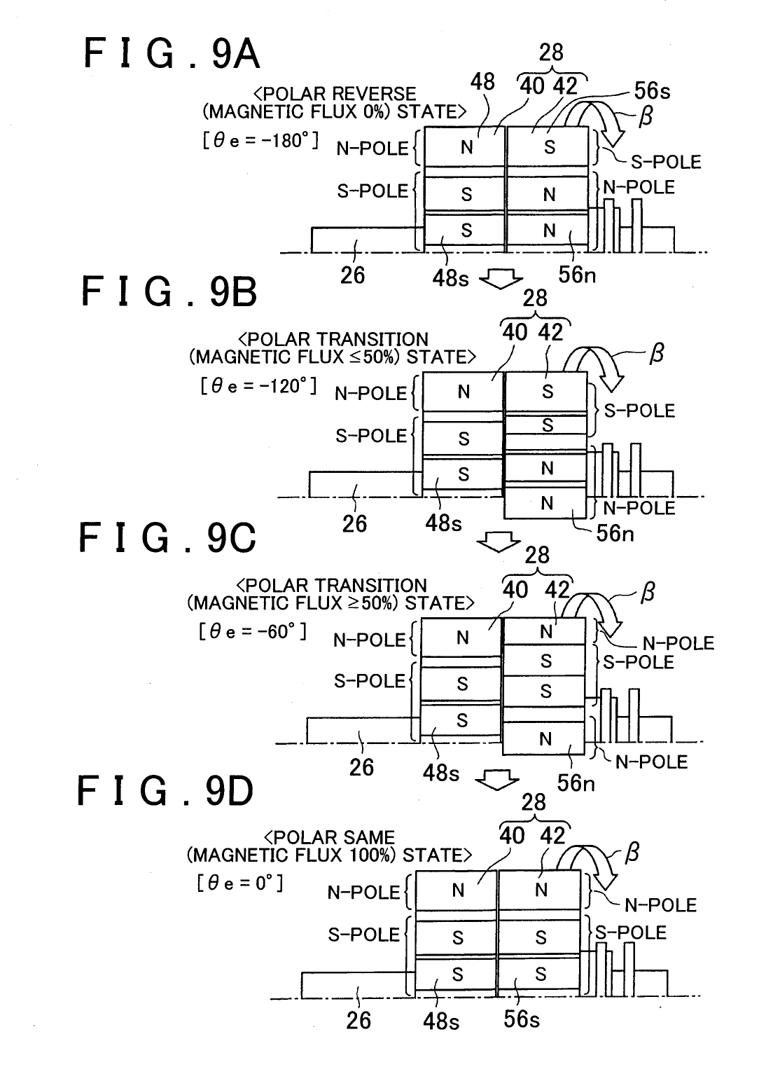

Meanwhile, explanations are given as to the control for the transition of the rotor phase relationship achieving positive directional transition of θe for −180°≦θe<0°. FIG. 8 A-D and FIG. 9 A-D shows the transition in the positive direction of θe for −180°≦θe<0°. In the polar reverse state of θe=−180°, it is possible to perform vector control of the stator coil current flowing through the three-phase stator coil 38 so as to generate the stator magnetic field achieving a magnetic pole in a specific direction. In this instance, in order to generate the magnetic flux in the same direction as the reference magnet 48s, it is possible to generate the stator magnetic field in a direction which is deviated by θe/2 in phase with respect to the first magnet 48s of the first rotor element 40, that is, a direction halving the circumferential direction interval of the homopolar magnets 48s, 56s of the first rotor element 40 and the second rotor element 42, for generating a magnetic flux in the same direction as the reference magnet 48s. In this instance, it is possible to generate the torque in the positive direction, that is, the torque attracting the homopolar magnets 48s, 56s in each rotor element 40, 42 due to the generation of the magnetic attraction force acting between the stator magnetic field and the magnetic flux of magnets in each rotor element 40, 42. The above explanation refers to the stator magnetic flux corresponding to the magnets 48s, 56s, and can be applied to the stator magnetic flux corresponding to the magnets 48n, 56n except that the direction is opposite. FIG. 8 A-D shows the attraction force acting in both directions indicated by an arrow 8, between the magnetic flux shown by the arrow N, S generated by the stator magnetic field and the magnets 48n, 48s, 56n, 56s of the rotor 28.

The abovementioned torque in the positive direction allows the transition of θe in the positive direction. In this instance, it is necessary to control the magnetic flux direction of the stator magnetic field generated by vector control to be synchronized with the θe transition. In view of this, it is necessary to control so as to generate the stator magnetic field achieving the generation of magnetic flux in the direction corresponding to detection values of two rotation angle sensors 32, 34 detecting the rotation angle of each rotor element 40, 42, which are acquired or received in the controller 70.

The torque is generated between the rotor elements 40, 42 by the stator magnetic field. The stator magnetic field is only magnetic field in d-axis direction of combined magnetic field of two rotor elements 40, 42, which serves as a phase center of magnetic field of the homopolar magnets of two rotor elements 40, 42, not so as to generate the torque acting externally via the rotary shaft 26.

When the effective magnetic flux of the rotor 28 amounts to a desired value, it is possible to set the stator magnetic field to zero by performing “positive torque generation operation” for transition of rotor phase relationship in positive direction of θe as described above. For example, it is possible to perform vector control of the stator current so as to achieve the d-axis magnetic flux of zero, among the d-axis magnetic flux and the q-axis magnetic flux resulting from the stator magnetic field. In this case, the inter-rotor magnetic torque serves as a torque reversing to the state of θe=−180°, acting between the rotor elements 40, 42 in the negative direction of FIG. 6. However, with the function of the one-direction clutch 30 provided between the second rotor element 42 and the rotary shaft 26, it is possible to keep constant the rotor phase relationship at the inter-rotor phase θe as “a phase fixing operation” without altering the inter-rotor phase θe to the negative direction.

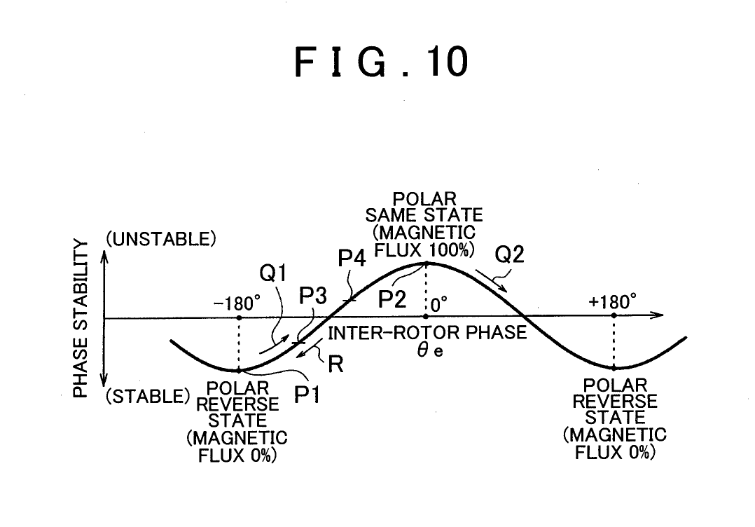

FIG. 10 schematically shows the relationship between the inter-rotor phase θe and the stability of rotor phase relation. For the transition of the inter-rotor phase θe in positive direction towards the polar same state at point P2 from the polar reverse state at point P1, it is possible to control so as to generate the stator magnetic field achieving the generation of the d-axis direction as described above, for the purpose of altering the inter-rotor phase θe and the stability in arrow Q1 direction. In this instance, the inter-rotor magnetic torque is generated in the negative direction achieving the transfer in R direction, that is, phase stabilizing direction, for the desired value of the effective magnetic flux achieving the stator magnetic field of zero. However, with the function of the one-direction clutch 30, it is possible to maintain the desired state, for example points P3 and P4. In this condition, the effective magnetic flux amount of the rotor 28 increases from the effective magnetic flux of zero in the polar reverse state.

Further increase in the effective magnetic flux can be achieved by repetitive the above positive torque generation operation and phase fixing operation. With this operation, it is possible to achieve transition of the inter-rotor phase from the magnetic flux 0% state to the magnetic flux 100% state.

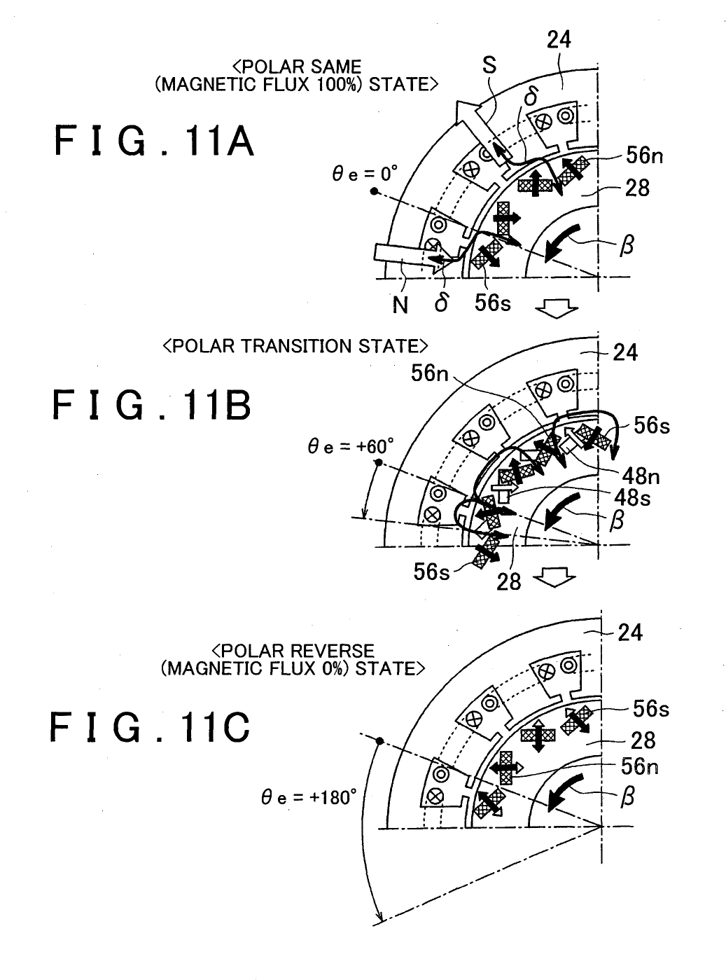

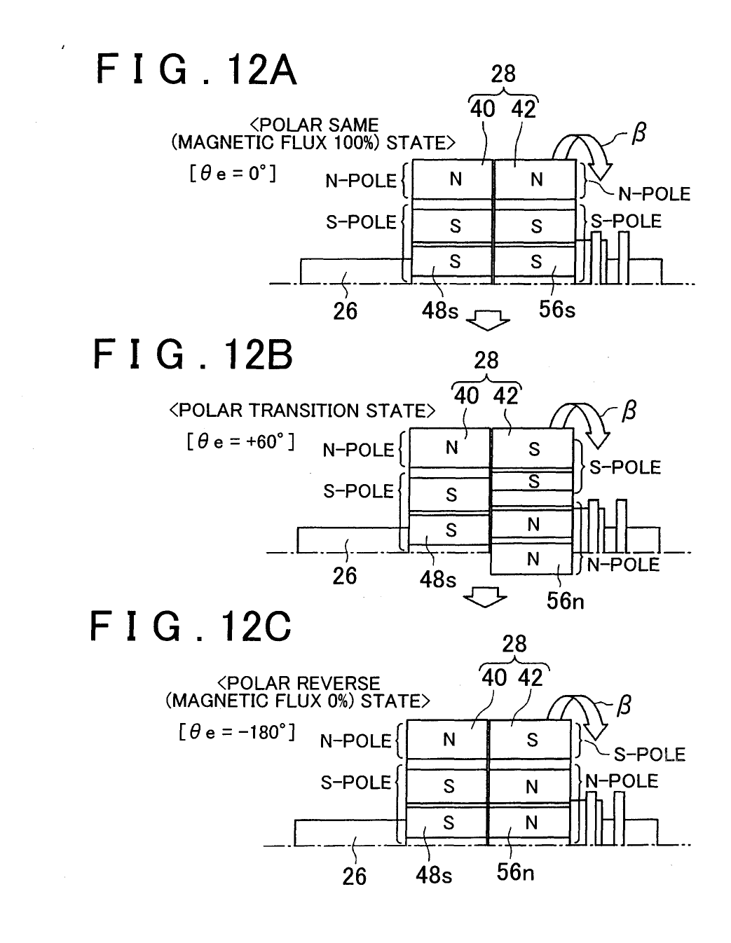

Next, explanations are given as to the control for the transition of the rotor phase relationship achieving positive directional transition of θe for 0°≦θe<+180°. FIG. 11 A-C and FIG. 12 A-C show the transition in the positive direction of θe for 0°≦θe≦+180°. For the transition in positive direction from the polar same state of θe=0°, the vector control of the stator coil current is performed so as to generate the stator magnetic field causing phase difference between the rotor elements 40, 42, that is positive inter-rotor phase θe, at least at a driving initial state of the second rotor element 42. In this instance, the vector control of the stator coil current is performed so as to generate the stator magnetic field increasing the phase difference between the homopolar magnets of two rotor elements 40, 42 at the driving initial state of the second rotor element 42. For example, the stator magnetic field is generated so as to cause q-axis magnetic flux at a specific amplitude which gives the torque in arrow β direction (FIG. 11 A-C) temporarily to the rotor 28 at the driving initial state.

In this instance, the vector control of the stator coil current is performed so as to form the stator magnetic field causing magnetic flux in a specific direction. In this stator magnetic field, as shown in FIG. 1A and FIG. 12A, it is possible to form the stator magnetic flux in the same direction as the magnetic flux of the homopolar magnets in two rotor elements 40, 42 with same phase, at a position which is deviated in positive direction of the inter-rotor phase θe, for example the position indicated by arrow N in FIG. 11A. In this condition, the stator magnetic field generates β-directional torque with the same dimension as each rotor element 40, 42. However, the first rotor element 40 unitarily formed with the rotary shaft 26 has a large rotary inertia, while the second rotor element 42 not unitarily formed with the rotary shaft 26 has a smaller rotary inertia than the first rotor element 40. For this reason, it is possible to rotate the second rotor element 42 in β direction in relation to the first rotor element 40 by the torque in the positive direction shown in FIG. 7 acting on the second rotor element 42.

With this torque in the positive direction, it is possible to achieve transition of the inter-rotor phase to the state of θe=+180°.

In this instance, in FIG. 10, in the polar same state at the point P2, the control for causing the stator magnetic field in the above way makes it possible to change the inter-rotor phase θe and the stability in the arrow Q2 direction. In this instance, the positive inter-rotor magnetic torque in FIG. 6 always acts in a 0°<θe<+180° region, thus making it possible to perform the transition to the polar reverse state, that is, the phase stable state, without need for external addition of driving torque.

As described above, for the purpose of generating, the stator magnetic field forming magnetic poles in specific direction in the polar same state, it is possible to employ a configuration in which the vector control of the stator coil current is performed so as to rotate two rotor elements 40, 42 in the same direction with the controller 70 and to rotate the second rotor element 42 in relation to the first rotor element 40. For example, the vector control of the stator coil current may be performed for generation of the stator magnetic field causing pulse-like magnetic flux at a position which allows two rotor elements 40, 42 to rotate in the same direction.

According to the rotary electric machine control system 10 and the method for controlling the rotary electric machine 20 as described above, it is possible to alter the effective magnetic flux amount of the rotor 28 by altering the rotor phase relationship between two rotor element 40, 42 without need for specialized driving source such as actuator. In addition, it is possible to control the effective magnetic flux amount at an arbitrary value because the rotor phase relationship between the rotor elements 40, 42 is controlled arbitrarily without generation of the torque acting on the outside of the rotary electric machine 20 by the rotary shaft 26. As a result, it is possible to be free from the growth in cost and body of the actuator, compared to conventional techniques needing the actuator.

In addition, one-direction clutch 30 is provided between the second rotor element and the rotary shaft 26. The one-direction clutch 30 prevents the second rotor element 42 from rotating to the polar reverse state in relation to the first rotor element 40 with the inter-rotor magnet torque acting on two rotor element 40, 42, for the transition of the inter-rotor phase from the polar reverse state to the polar same state. For this reason, it is possible to maintain the rotor phase relationship without external electric coercive force when the effective magnetic flux amount of the rotor 28 is a desired value. For this reason, it is not necessary to maintain the rotor phase relationship with actuator coercive force, thereby energy loss can be reduced.

Besides, the controller 70 performs vector control of the stator coil current for transition of the rotor phase θe from the polar reverse state to the polar same state. Thereby, in spite of the presence of the negative rotor magnet torque resulting from attraction force between magnets, without need for providing the driving force such as actuator, it is possible to perform transition of the rotor phase relationship to the polar same state.

Besides, the controller 70 performs vector control of the stator coil current so as to generate a phase difference between the rotor elements 40, 42 at least during a driving initial period of the second rotor element 42 in a transition from the polar same state to the polar reverse state. For this reason, it is possible to reduce the effective magnetic flux amount down from 100% to 0% without external driving force due to the rotor magnetic torque between the rotor elements 40, 42 only by causing the predetermined stator magnetic field during driving initial period.

### Second Embodiment

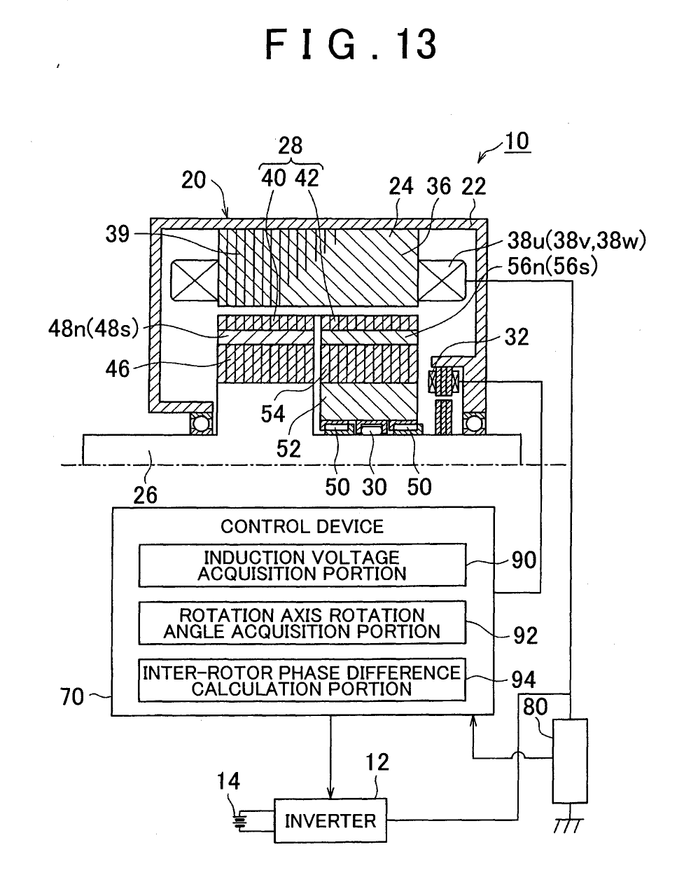

FIG. 13 shows the configuration of the rotary electric machine control system 10 according to the second embodiment of the present invention. The rotary electric machine 20 is not provided with a rotation angle sensor 34 (FIG. 1) detecting the rotation angle of the second rotor element 42 in the abovementioned first embodiment. Instead, the rotary electric machine control system 10 is provided with an induction voltage detection circuit 80 detecting the induction voltage of at least one-phase stator coil 38. The induction voltage detection circuit 80 detects an induction voltage generated at the stator coil 38 resulting from the effective magnetic flux amount of the rotor 28 by the rotation of the first rotor element 40 and the second rotor element 42. The detection value of the induction voltage is transmitted to the controller 70.

The controller 70 includes an induction voltage acquisition portion. 90, a rotation axis rotation angle acquisition portion 92, and an inter-rotor phase difference calculation portion 94. The induction voltage acquisition portion 90 acquires the detection value of the induction voltage received in the controller 70. The rotation axis rotation angle acquisition portion 92 receives and acquires the detection value of the rotation angle of the rotary shaft 26 sent from the rotation angle sensor 32. The inter-rotor phase difference calculation portion 94 calculates the inter-rotor phase θe as the inter-rotor relative phase difference on the basis of the detection value of the induction voltage and the detection value of the rotation angle sensor 32.

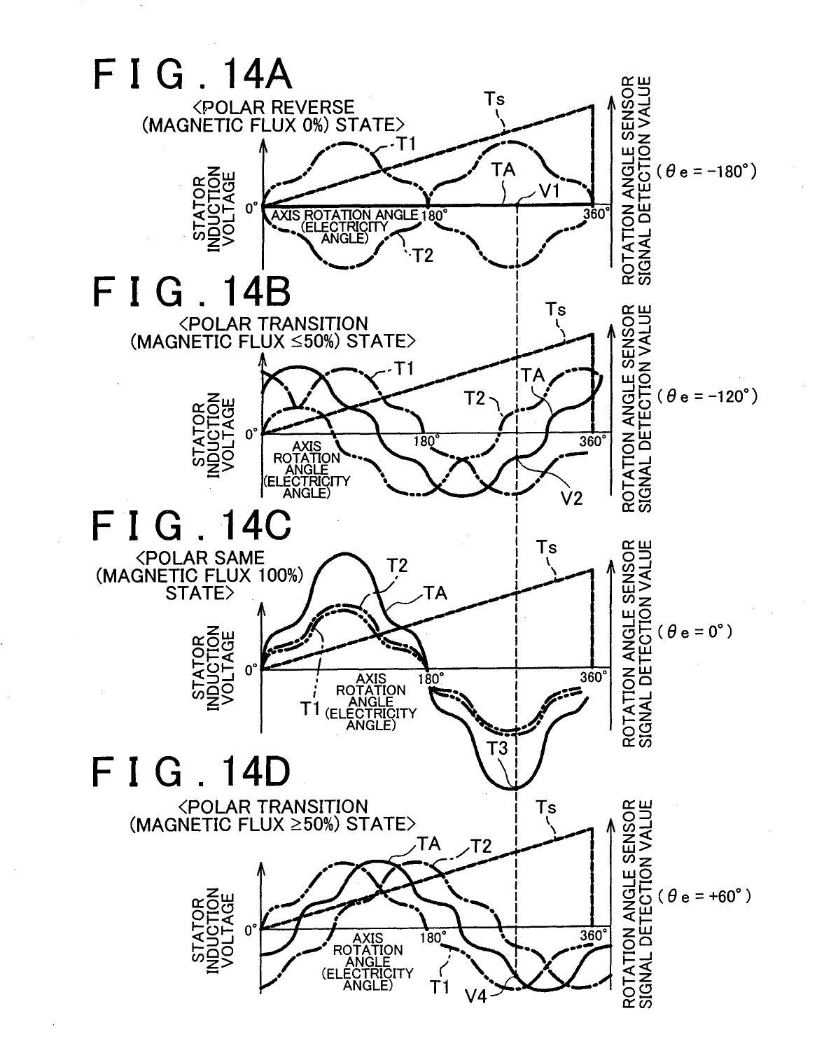

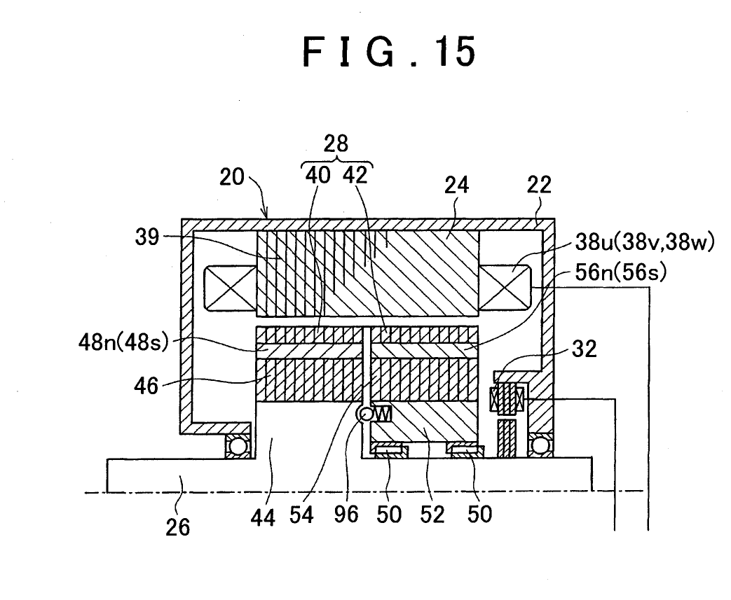

FIG. 14A-D shows four examples of relationship between axis rotation angle (electricity angle) and the stator induction voltage with different inter-rotor phase θe in this embodiment. FIG. 14A-D shows the induction voltage resulting from the magnetic flux of the first rotor element 40 indicated by two-points dotted line T1, the induction voltage resulting from the magnetic flux of the second rotor element 42 indicated by one-point dotted line T2, and combined induction voltage resulting from the combination of magnetic flux of two rotor elements 40, 42 indicated by real line TA. The dot line Ts shows signal detection value as the detection signal of the rotation angle sensor 32. The signal detection value of the rotation angle sensor 32 is proportional to the axis rotation angle expressed as the electricity angle.

As shown in FIG. 14A-D, it is possible to calculate the inter-rotor phase θe corresponding to the current state at almost all of rotation angles of the rotary shaft 26 from the stator induction voltage and the rotation angle of the rotary shaft 26. For example, in case of obtaining one of combined induction voltages V1, V2, V3 and V4 at the rotation angle of the rotary shaft 26, the inter-rotor phase difference calculation portion 94 determines the inter-rotor phase θe as one of −180°, −120°, 0°, +60° as the inter-rotor phase θe corresponding to the current state. In this instance, it is possible to calculate the inter-rotor phase θe with use of a map indicating the relationship among the inter-rotor phase θe which is stored in the storage portion in advance, the combined induction voltage and the rotation angle of the rotary shaft 26. In order to calculate the inter-rotor phase θe with, use of a relationship not stored in the storage portion, the inter-rotor phase θe may be calculated by interpolation using a relationship of a map or predetermined relationship. As the combined induction voltage is always zero at the polar reverse state, this may not distinct from other states with the combined induction voltage of zero. In this case, it is possible to arrange for not calculating the inter-rotor phase θe using the detection value of the state.

With the above configuration, it is possible to calculate the inter-rotor phase θe by utilizing the combined induction voltage and the detection value of the rotation angle of the rotary shaft 26 during the rotation of the rotary shaft 26, for the transition of the inter-rotor phase. For this reason, the rotation angle sensor is not necessary for detecting the rotation angle of the second rotor element 42, and it reduces a production cost. Besides, it is not necessary to provide the setting portion of the rotation angle sensor for the detection of the rotation angle of the second rotor element 42 to the rotary electric machine 20, it enables to achieve a reduced dimension. Other configuration and functions are the same as the configuration shown in FIG. 1 to FIG. 12A-C.

### Third Embodiment

FIG. 15 shows a cross-sectional surface of the rotary electric machine 20 according to third embodiment of the present invention. The rotary electric machine 20 is not provided with one-direction clutch 30 (FIG. 1). The rotary electric machine 20 has a tubular protrusion 44 provided to the rotary shaft 26 fixed to the first rotor element 40, and a detent mechanism 96 provided between lateral surfaces in axial direction facing the second rotor element 42. The detent mechanism 96 maintains the polar same state when the first rotor element 40 and the second rotor element 42 coincide with each other in the inter-rotor while the effective magnetic flux is 100%. The detent mechanism 96 maintains the polar same state when the two rotor elements 40, 42 with a spring force provided to this ball by engaging a concave portion provided to the lateral surface in axis direction of the tubular protrusion 44 with a concave portion provided to the lateral surface in axis direction of the interior holding portion 52.

The detent mechanism 96 does not release the lock with the inter-rotor magnet torque, and generates a specific fixing force so as to release the lock with the driving force for the transition of the rotor phase relationship arising from the stator magnetic field.

Besides, the controller 70 performs vector control of the stator coil current so as to maintain the inter-rotor phase only at either one of two switching states, the polar reverse state with the effective magnetic flux amount of 0% and the polar same state.

According to the above configuration, it is not necessary to provide the one-direction clutch 30 for regulating the rotation direction of the second rotor element 42 in one direction, thereby achieving a reduced cost. Other configurations and functions are the same as the above configurations shown in FIG. 1 to FIG. 12A-C. In the above configurations shown in FIG. 1 to FIG. 12A-C, it is also possible to provide the detent mechanism 96 as shown in the abovementioned FIG. 15. In this instance, it is easy to maintain the same polar state with the effective magnetic flux of 100%. In addition, as in the case of the same polar state, or instead of this case, it is also possible to provide the detent mechanism at a portion to maintain a desired rotor phase relationship other than the same polar state. Besides, the detent mechanism can be also provided between lateral surfaces of the first rotor element 40 and the second rotor element 42 which face each other in axial direction.

### Fourth Embodiment

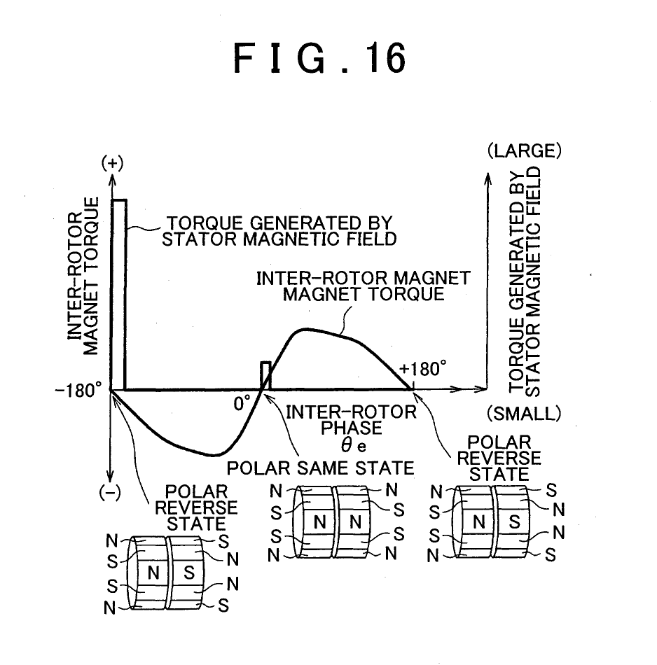

FIG. 16 shows the relationship among torque generated by stator magnetic field in the second rotor element 42, inter-rotor magnet torque, and inter-rotor phase θe, according to the fourth embodiment of the present invention. In this embodiment, as in the above configuration of FIG. 15, the controller 70 performs vector control of the stator coil current so as to maintain the inter-rotor phase θe only at either one of two switching states, the polar reverse state with the effective magnetic flux amount of 0% and the polar same state with the effective magnetic flux amount of 100%. In this instance, the vector control is performed to generate an energy for transition to θe=0° at the condition of θe=−180°, for transition of the inter-rotor phase θe from the polar reverse state to the polar same state. In this instance, the vector control of the stator coil current is performed so as to instantaneously supply the attraction energy arising from the inter-rotor magnet torque which acts on the rotor 28 during entire transition from θe=−180° to 0°, and the attraction energy corresponding to the inertial energy for the rotation of the second rotor element 42 during the driving initial period of the second rotor element 42.

For the transition from the polar same state to the polar reverse state, the vector control of the stator coil current is performed so as to rotate both of two rotor elements 40, 42 in the same direction. For example, the vector control of the stator coil current is performed so as to generate the stator magnetic field causing pulsed magnetic flux with rectangular waveform or triangular waveform at a position that allows both of two rotor elements 40, 42 to rotate in the same direction. The torque generated by the stator magnetic field in this instance can be smaller than the torque provided for the transition from the polar reverse state.

With the above configuration, it is not necessary to perform the vector control for generating the stator magnetic flux on the basis of the inter-rotor phase θe in the whole range of transition operation of the rotor phase relationship. For this reason, it is not necessary to detect the inter-rotor phase θe in the whole range for the detection of the inter-rotor phase difference including the detection of the inter-rotor phase difference of FIG. 13. For this reason, it is possible to simplify hardware configuration and software configuration for the control of inter-rotor phase. Other configurations and functions are the same as the above configurations shown in FIG. 1 to FIG. 12 A-C.

The embodiments of the present invention are explained above. The present invention is not limited to such embodiments and can be implemented in various configurations without departing from the scope of the present invention.

The above explanation is made as to the configuration in which a pair of two magnets is disposed in V-shaped form in each rotor element 40, 42. The present invention is not limited to this, and it is possible to employ a configuration in which each magnet is disposed along circumferential direction in each rotor element 40, 42, for example.

1. A control system comprising:
a rotary electric machine including:
a stator including stator coils which are disposed at plural positions in circumferential direction,
a rotor including a first rotor element and a second rotor element which are rotatable inside of the stator and disposed to be separated from each other in axial direction, the first rotor element including a plurality of first magnets with different polarities disposed alternately in the circumferential direction, the first rotor element being fixed to a rotary shaft, the second rotor element including a plurality of second magnets with different polarities disposed alternately in the circumferential direction, the second rotor element being rotatably provided to the rotary shaft; and
a controller configured to control a stator coil current, the controller being configured to perform vector control of the stator coil current for transition of an inter-rotor phase that is a relative phase difference of the second rotor element in relation to the first rotor element.

2. The control system according to claim 1, wherein
the controller is configured to perform vector control of the stator coil current, so as to achieve a transition of at least the inter-rotor phase from the inter-rotor phase in a polar reverse state to the inter-rotor phase in a polar same state,
the polar reverse state is a state achieving coincidence in phase between the first magnet and the second magnet with antipolarity in their circumferential directions,
the polar same state is a state achieving coincidence in phase between the first magnet and the second magnet with homopolarity in their circumferential directions.

3. The control system according to claim 2, wherein
the controller is configured to perform vector control of the stator coil current so as to generate a torque allowing the first rotor element and the second rotor element to rotate in opposite directions, and generates a torque not contributing rotation of the rotor, when the inter-rotor phase is positioned between the inter-rotor phase in the polar reverse state and the inter-rotor phase in the polar same state.

4. The control system according to claim 1, wherein
the controller is configured to perform vector control of the stator coil current so as to increase a phase difference between the first rotor element and the second rotor element, during a driving initial period for rotationally driving the second rotor element in relation to the first rotor element so as to change at least the inter-rotor phase from a predetermined value.

5. The control system according to claim 4, wherein
the controller is configured to perform vector control of the stator coil current so as to generate the phase difference at least during a driving initial period of the second rotor element in a transition from the inter-rotor phase in the polar same state to the inter-rotor phase in the polar reverse state, the inter-rotor phase being a predetermined value,
the polar same state is a state achieving coincidence in phase between the first magnet and the second magnet with homopolarity in their circumferential directions,
the polar reverse state is a state achieving coincidence in phase between the first magnet and the second magnet with antipolarity in their circumferential directions.

6. The control system according to claim 5, wherein
the controller is configured to perform vector control of the stator coil current so as to rotate the second rotor element in relation to the first rotor element and rotate both of the first rotor element and the second rotor element in the same direction, at least during a driving initial period of the second rotor element in a transition from the polar same state to the polar reverse state.

7. The control system according to claim 4, wherein
the controller is configured to perform vector control of the stator coil current so as to supply an attraction force energy for a short time for transition of the second rotor element to the polar same state during a driving initial period of the second rotor element in a transition from the polar reverse state to the polar same state, the inter-rotor phase being a predetermined value,
the polar reverse state is a state achieving coincidence in phase between the first magnet and the second magnet with antipolarity in their circumferential directions,
the polar same state is a state achieving coincidence in phase between the first magnet and the second magnet with homopolarity in their circumferential directions.

8. The control system according to claim 1, further comprising:
an one-direction clutch provided between the second rotor element and the rotary shaft, the one-direction clutch configured to prevent a rotation allowing the second rotor element to reverse to the polar reverse state in relation to the first rotor element with an inter-rotor magnetic torque acting between the first rotor element and the second rotor element in a transition of the inter-rotor phase from the inter-rotor phase in the polar reverse state to the inter-rotor phase in the polar same state,
the polar reverse state is a state achieving coincidence in phase between the first magnet and the second magnet with antipolarity in their circumferential directions,
the polar same state is a state achieving coincidence in phase between the first magnet and the second magnet with homopolarity in their circumferential directions.

9. The control system according to claim 1, further comprising:
a rotation angle sensor detecting a rotation angle of the rotary shaft,
wherein the controller is configured to calculate the inter-rotor phase, on the basis of a detection value of induction voltage generated in the stator coil resulting from the rotation of the first rotor element and the second rotor element, and a detection value of the rotation angle sensor.

10. The control system according to claim 1, further comprising:
a detent mechanism being provided between the second rotor element and either one of the first rotor element and a member fixed to the first rotor element, wherein the detent mechanism maintains the polar same state when the inter-rotor phase is the inter-rotor phase in polar same state, wherein the polar same state is a state achieving coincidence in phase between the first magnet and the second magnet with homopolarity in their circumferential directions.

11. The control system according to claim 1, wherein
the controller is configured to perform vector control of the stator coil current so as to maintain the inter-rotor phase only at the inter-rotor phase in either of the polar reverse state and the polar same state,
the polar reverse state is a state achieving coincidence in phase between the first magnet and the second magnet with antipolarity in their circumferential directions,
the polar same state is a state achieving coincidence in phase between the first magnet and the second magnet with homopolarity in their circumferential directions.

12. A method for controlling a control system including rotary electric machine and a controller, the rotary electric machine including:
a stator including stator coils which are disposed at a plurality of positions in circumferential direction, and
a rotor including a first rotor element and a second rotor element which are rotatable inside of the stator and disposed to be separated from each other in axial direction, the first rotor element including a plurality of first magnets with different polarities disposed alternately in circumferential direction, wherein the first rotor element being fixed to a rotary shaft, the second rotor element including a plurality of second magnets with different polarities disposed alternately in circumferential direction, the second rotor element being rotatably provided to the rotary shaft; and
the controller being configured to control a stator coil current,
the method comprising:
performing vector control of the stator coil current for transition of an inter-rotor phase that is a relative phase difference of the second rotor element in relation to the first rotor element, with the controller.
